(19) United States
(12) Patent Application Publication
(10) Pub. No.: US 2007/0058214 A1
(43) Pub. Date: Mar. 15, 2007

(54) Image reading apparatus, image reading method and storage medium for storing program

(75) Inventor: Mikimasa Honma, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/299,839

(22) Filed: Dec. 13, 2005

(30) Foreign Application Priority Data
Sep. 9, 2005 (JP) 2005-261958

(51) Int. Cl. H04N 1/04

(52) U.S. Cl. 358/474; 358/540

(57) ABSTRACT

An image reading apparatus including: an image reading section for reading a document to obtain a document image; and a control section for adding an additional image to a document image corresponding to one page in the document image obtained by the image reading section under a dual page mode to generate image information of the document image added with the additional image, wherein the control section adds the additional image to the document image corresponding to one page away from a binding margin region.

### BACKGROUND OF THE INVENTION

1. Field of the Invention

The present invention relates to an image reading apparatus, an image reading method, and a storage medium for storing a program. In particular, the present invention relates to an image reading apparatus, an image reading method, and a storage medium for storing a program, for adding additional image to document image.

2. Description of Related Art

Conventionally, in an image forming apparatus for forming an image on a recording paper based on a document image, a technique for adding, in addition to the document image, an additional image (e.g., image of a time, a date, a page number, a document number, a name such as a document preparer, “FOR INTERNAL USE ONLY” or “IMPORTANT”) has been known.

For example, when image data for one sheet of a document is divided and the divided pieces of image data are recorded on a plurality of recording papers in an image recording apparatus having a function for automatically printing a page number on a recorded paper, a technique is suggested for adding a hierarchized page number consisting of a parent page number corresponding to the document page number and a child page number allocated based on the printing order (e.g., see Japanese Patent Laid-Open Publication No. 7-66941).

Another technique has been used to add, when an image reading apparatus (e.g., scanner) is used to read a document, an additional image to the document image to generate image information. In this case, an end section of the image obtained by reading the document has inaccurate image information due to the floating of the document for example. Furthermore, this technique does not allow the end section of the obtained image to be printed in the printing operation because the end section is a page margin, thus using image data at the scanned-and-trimmed region 610 inside of the scan region 600 as shown in FIG. 16 to add the additional image 620 to the scanned-and-trimmed region 610.

However, when a two-page spread document (e.g., book, catalogue) is evenly divided to one left page and one right page to be read in a dual page mode, the scanned-and-trimmed region 710 is set to the scan region 700 for the two pages as shown in FIG. 17A. When an additional image is added to the upper right position of the document image, the additional image 720 is added, as shown in FIG. 17B, to the upper right positions of the left page and the right page of the scanned-and-trimmed region 710, respectively. This has caused a risk as shown in FIG. 17C in which, when the left page of the document image added with the additional image 720 is printed, the additional image 720 may be hidden by the page margin region 730.

### SUMMARY

It is an object of the present invention to prevent the additional image from being hidden, when an additional image is added to the document image read by the dual page mode.

In order to solve the above problem, according to the first embodiment reflecting the first aspect of the present invention, an image reading apparatus comprises: an image reading section for reading a document to obtain a document image; and a control section for adding an additional image to a document image corresponding to one page in the document image obtained by the image reading section under a dual page mode to generate image information of the document image added with the additional image, wherein the control section adds the additional image to the document image corresponding to one page away from a binding margin region.

Preferably, the image reading apparatus further comprising an operation section for accepting an input from a user; wherein the dual page mode is set based on a user instruction from the operation section.

Preferably, the control section adds the additional image to a position that is shifted by a width of the binding margin region from an end section of the document image corresponding to one page, the binding margin region being positioned at the end section.

Preferably, the control section adds the additional image to a position that is shifted by a width set by the user through the operation section from an end section of the document image corresponding to one page, the binding margin region being positioned at the end section.

Preferably, the control section adds the additional image to a position that is shifted by a width obtained by adding a width of the binding margin region and a width set by the user through the operation section from an end section of the document image corresponding to one page, the binding margin region being positioned at the end section.

Preferably, the control section changes a size of the additional image to add the additional image to the document image corresponding to one page away from the binding margin region.

Preferably, the control section changes the font size used in the additional image to add the additional image to the document image corresponding to one page away from the binding margin region.

Preferably, the operation section accepts a specified region to which the additional image is to be added, from the user; and when the specified region is a region at which the binding margin region is positioned, the control section adds the additional image to the document image corresponding to one page away from the binding margin region.

Preferably, the image reading apparatus further comprising an operation section for accepting a specified region to which the additional image is to be added, from the user; and when the specified region is a region at which the binding margin region is positioned, the control section adds the additional image to the document image corresponding to one page away from the binding margin region.

According to the second embodiment reflecting a second aspect of the present invention, an image reading method comprises: obtaining a document image by an image reading section under a dual page mode; and adding an additional image to a document image corresponding to one page in the document image obtained by the image reading section away from a binding margin region to generate image information of the document image added with the additional image.

Preferably, in the adding of the additional image, the additional image is added to a position that is shifted by a width of the binding margin region from an end section of the document image corresponding to one page, the binding margin region being positioned at the end section.

Preferably, in the adding of the additional image, the additional image is added to a position that is shifted by a width set by the user from an end section of the document image corresponding to one page, the binding margin region being positioned at the end section.

Preferably, in the adding of the additional image, the additional image is added to a position that is shifted by a width obtained by adding a width of the binding margin region and a width set by the user from an end section of the document image corresponding to one page, the binding margin region being positioned at the end section.

Preferably, in the adding of the additional image, a size of the additional image is changed to add the additional image to the document image corresponding to one page away from the binding margin region.

Preferably, in the adding of the additional image, a font size used in the additional image is changed to add the additional image to the document image corresponding to one page away from the binding margin region.

Preferably, the image reading method comprising accepting a specified region to which the additional image is to be added, from a user; wherein in the adding of the additional image, when the specified region specified in the accepting of the specified region is a region at which the binding margin region is positioned, the additional image is added to the document image corresponding to one page away from the binding margin region.

According to the third embodiment reflecting a third aspect of the present invention, a storage medium for storing a program for causing a computer to execute: obtaining a document image by an image reading section under a dual page mode; and adding an additional image to a document image corresponding to one page in the document image obtained by the image reading section away from a binding margin region to generate image information of the document image added with the additional image.

Preferably, in the adding of the additional image, the additional image is added to a position that is shifted by a width of the binding margin region from an end section of the document image corresponding to one page, the binding margin region being positioned at the end section.

Preferably, in the adding of the additional image, the additional image is added to a position that is shifted by a width set by the user from an end section of the document image corresponding to one page, the binding margin region being positioned at the end section.

Preferably, in the adding of the additional image, the additional image is added to a position that is shifted by a width obtained by adding a width of the binding margin region and a width set by the user from an end section of the document image corresponding to one page, the binding margin region being positioned at the end section.

Preferably, in the adding of the additional image, a size of the additional image is changed to add the additional image to the document image corresponding to one page away from the binding margin region.

Preferably, in the adding of the additional image, a font size used in the additional image is changed to add the additional image to the document image corresponding to one page away from the binding margin region.

Preferably, the computer is caused to further execute: accepting a specified region to which the additional image is to be added, from a user; and in the adding of the additional image, when the specified region specified in the accepting of the specified region is a region at which the binding margin region is positioned, the additional image is added to the document image corresponding to one page away from the binding margin region.

### BRIEF DESCRIPTION OF THE DRAWINGS

The present invention will become more fully understood from the detailed description given below and the accompanying drawings which are given by way of illustration only, and thus are not intended to limit the scope of the invention, and wherein:

FIG. 1 is a schematic view illustrating the entire structure of the image forming apparatus 1 in Embodiment 1;

FIG. 2 is a block diagram illustrating the functional configuration of the image forming apparatus 1;

FIG. 3 illustrates a binding margin region;

FIG. 4 illustrates the structure of the operation section 200;

FIG. 5 is a flowchart illustrating the processing A for generating a stamp-added image;

FIG. 6 is a flowchart illustrating a processing for setting a stamp function;

FIG. 7 illustrates the setting screen 212 for selecting a stamp format;

FIG. 8 illustrates the setting screen 213 for specifying the type of a formulaic stamp and the stamp position;

FIG. 9 illustrates the setting screen 214 for fine-adjusting the stamp position;

FIG. 10 illustrates an exemplary image data generated when a stamp is added to the binding margin region side of the document image corresponding to a left page;

FIG. 11 is a flowchart illustrating the processing B for generating a stamp-added image in Embodiment 2;

FIG. 12 illustrates an exemplary image data generated when a stamp is added to the binding margin region side of the document image corresponding to a left page and when a user setting width is not set;

FIG. 13 illustrates an exemplary image data generated when a stamp is added to the binding margin region side of the document image corresponding to a left page and when a user setting width is set;

FIG. 14 is a flowchart illustrating processing C for generating a stamp-added image in Embodiment 3;

FIG. 15A illustrates the layout of a document image and a stamp before the font size of the stamp is changed;

FIG. 15B illustrates the layout of a document image and a stamp after the font size of the stamp is changed;

FIG. 16 illustrates a conventional technique for adding an additional image to a document image;

FIG. 17A illustrates the scan region 700 and the scanned-and-trimmed region 710 in a conventional dual page mode;

FIG. 17B illustrates the additional image 720 added to the upper right position of the scanned-and-trimmed region 710; and

FIG. 17C illustrates the additional image 720 hidden by the page margin region 730.

### DETAILED DESCRIPTION OF PREFERRED EMBODIMENTS

### Embodiment 1

First, Embodiment 1 of the present invention is described.

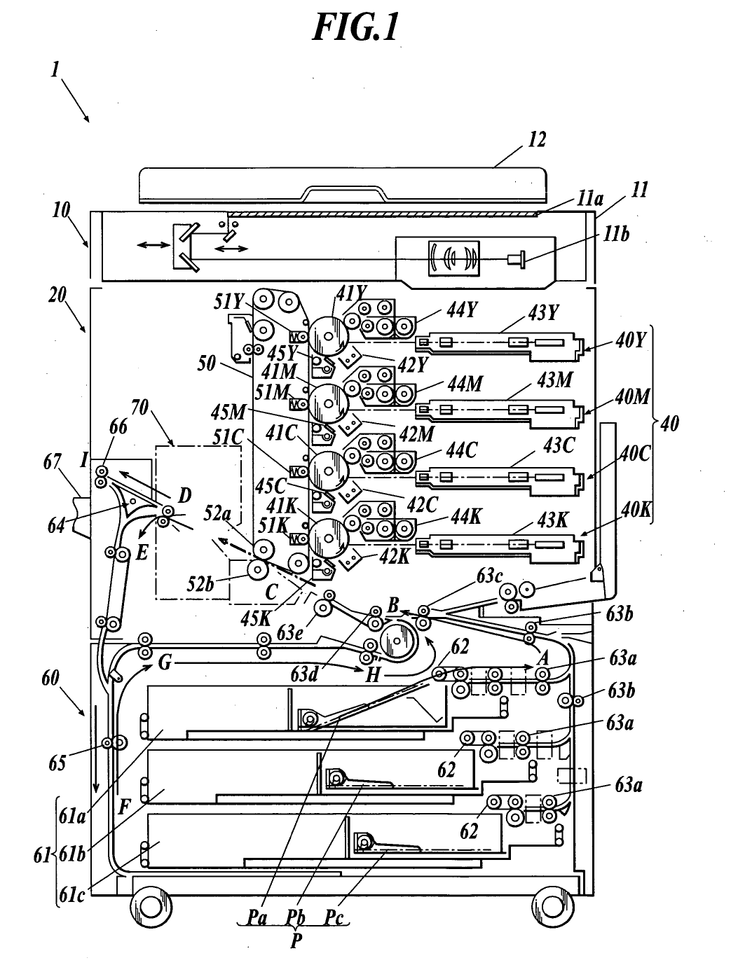

FIG. 1 is a schematic view illustrating the entire structure of the image forming apparatus 1 using the image reading apparatus of the present embodiment. The image forming apparatus 1 comprises the image reading section 10; the image forming apparatus body section 20 or the like. The image reading section 10 is provided at the upper part of the image forming apparatus body section 20 for example as shown in FIG. 1.

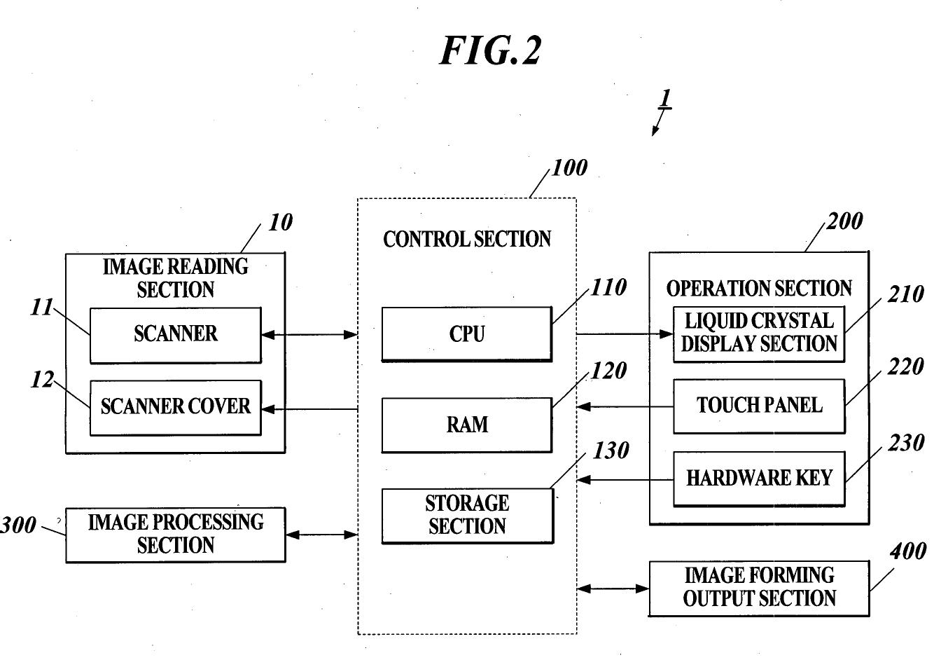

The image reading section 10 is structured to include the scanner 11, the scanner cover 12 or the like. The scanner 11 reads a document provided between the platen glass 11a and the scanner cover 12 to obtain a document image. Specifically, the image reading section 10 emits light to the document and the reflected light is read by the CCD (Charge Coupled Device) image sensor 11b. Then, the reflected light read by the CCD image sensor 11b is subjected to a photoelectric conversion and the image information (hereinafter referred to as image data) is outputted to the control section 100 (FIG. 2). When the dual page mode is set, the scanner 11 evenly divides a two-page spread document provided on the platen glass 11a to left and right pages and reads these pages.

The image forming apparatus body section 20 comprises: the image forming section 40, the intermediate transfer belt 50, the paper feeding section 60, and the fixation section 70 or the like. The respective sections form and output on the recording paper P, in accordance with an instruction from the control section 100, an image based on the image data read by the scanner 11 of the image reading section 10.

The image forming section 40 comprises: the yellow image forming section 40Y, the magenta image forming section 40M, the cyan image forming section 40C, and the black image forming section 40K. The structures of the respective image forming sections 40Y, 40M, 40C, and 40K have many common points and thus the following description mainly describes the yellow image forming section 40Y as an example thereof.

The yellow image forming section 40Y comprises the photo conductor drum 41Y, the charging apparatus 42Y, the exposure apparatus 43Y, the development apparatus 44Y, and the clearing apparatus 45Y. Based on the image data supplied from the control section 100, a yellow image is formed on the photo conductor drum 41Y. Embodiment 1 uses a tandem type image forming mechanism in which, based on the image data divided to pieces of data of the four colors of yellow (Y), magenta (M), cyan (C), and black (K), toner images of the respective colors are transferred to the intermediate transfer belt 50 to form (or print) the image on the recording paper P.

The surface of the photoconductor drum 41Y is uniformly charged by the charging apparatus 42Y in advance. Based on the yellow image data supplied from the control section 100, the exposure apparatus 43Y uses laser to form an electrostatic latent image on the photo conductor drum 41Y. The development apparatus 44Y makes yellow toner to adhere to the surface of the photo conductor drum 41Y on which the electrostatic latent image is formed by the exposure apparatus 43Y. The photoconductor drum 41Y on which the toner image is formed transfers the toner image to the intermediate transfer belt 50 abutted with the photo conductor drum 41Y in parallel with the axial direction. After the transfer of the toner image, the cleaning apparatus 45Y removes residual toner and residual charge adhering to the surface of the photoconductor drum 41Y.

In this manner, the respective toner images are transferred to the intermediate transfer belt 50 in an order of yellow (Y), magenta (M), cyan (C), and black (K), thereby forming one toner image.

The intermediate transfer belt 50 is supported by a plurality of rollers in a rotatable manner and is provided to pass between the photoconductor drums 41Y, 41M, 41C, and 41K and the first transfer rollers 51Y, 51M, 51C, and 51K, respectively. The first transfer rollers 51Y, 51M, 51C, and 51K use an elastic body (e.g., various springs, rubber) to abut the intermediate transfer belt 50 to the photoconductor drums 41Y, 41M, 41C, and 41K in a pressurized manner, thereby transferring the respective toner images of yellow (Y), magenta (M), cyan (C), and black (K) adhered on the photoconductor drums 41Y, 41M, 41C, and 41K onto the intermediate transfer belt 50.

The toner images firstly transferred sequentially on the intermediate transfer belt 50 are transported to the second transfer rollers 52a and 52b by the driving of the support roller for supporting the intermediate transfer belt 50. The second transfer rollers 52a and 52b collectively transfer the toner images to the recording paper P transported from the paper feeding section 60 (which is described later) (second transfer). The recording paper P transferred with the images (by the second transfer) is transported to the fixation section 70 and the toners are fixed due to heat fusion, thereby completing a color image.

The paper feeding section 60 is composed of: the paper feeding tray 61, the feed roller 62, the paper feeding roller 63a, the transportation rollers 63b, 63c, and 63d, the registration roller 63e, the diverging point 64, the inversion control roller 65, the paper ejection roller 66, and the paper ejection tray 67. The paper feeding section 60 feeds the recording paper P stored in the paper feeding tray 61 to the paper ejection tray 67 along a predetermined feed path (a series of guide rails for guiding the recording paper P from the point A to the point I shown in FIG. 1). The paper feeding tray 61 feeds appropriate recording paper P among the recording papers Pa, Pb, and Pc having various sizes stored in the paper feeding trays 61a, 61b, and 61c in accordance with the control by the control section 100.

When a both side printing is performed, the diverging point 64 and the inversion control roller 65 function as a stepper for inverting top and back faces of the recording paper P to transport the recording paper P.

Next, the control section 100 of the image forming apparatus 1 is described. As shown in FIG. 2, the control section 100 is connected to the image reading section 10, the operation section 200, the image processing section 300, the image forming output section 400 or the like.

As shown in FIG. 2, the control section 100 is structured to include the CPU (Central Processing Unit) 110, the RAM (Random Access Memory) 120, the storage section 130 or the like.

The CPU 110 performs various control operations in accordance with various processing programs for the image forming apparatus 1 stored in the storage section 130.

The CPU 110 adds additional image (hereinafter referred to as stamp) to the document image obtained by the scanner 11 to generate the image data of the stamp-added document image. In the dual page mode, the document image corresponding to every one page is added with a stamp. When the stamp is added, the stamp is added to a part within the region of the document image away from a binding margin region.

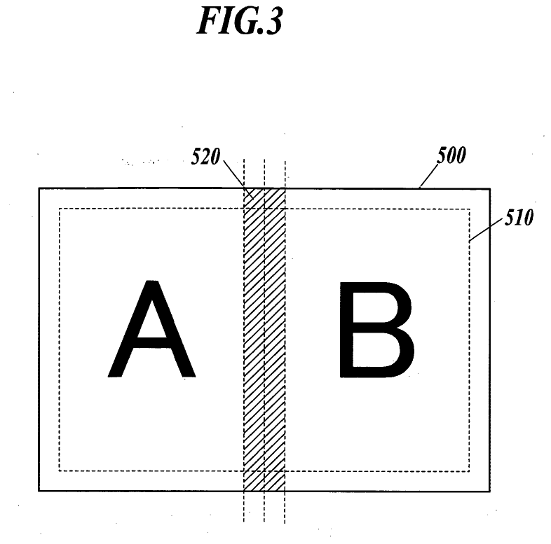

The binding margin region is a region that corresponds to a part to be bound of a two-page spread document under the dual page mode and that is used as a binding margin when resulting printed papers are stapled. As shown in FIG. 3, in the dual page mode, the scanner 11 reads the scan region 500 to trim the end section, thereby generating the scanned-and-trimmed region 510. Then, image data obtained by evenly-dividing the scanned-and-trimmed region 510 at the center is image data for the document image corresponding to one page. Specifically, the binding margin region 520 consists of the right end region of the left page (i.e., page showing “A”) and the left end region of the right page (i.e., page showing “B”). The binding margin region 520 has a predetermined width. The width of the binding margin region of each page is a half of the width of the binding margin region for the document image for two pages.

The RAM 120 includes a program storage region for developing a processing program or the like executed by the CPU 110 and a data storage region for storing a processing result generated when input data or the above processing program is executed, for example.

The storage section 130 stores a system program that can be executed by the image forming apparatus 1; various processing programs that can be executed by the system program; data used when these various processing programs are executed; and data obtained by the calculation processing by the CPU 110, for example. The program is stored in the storage section 130 in the form of program codes that can be read by a computer.

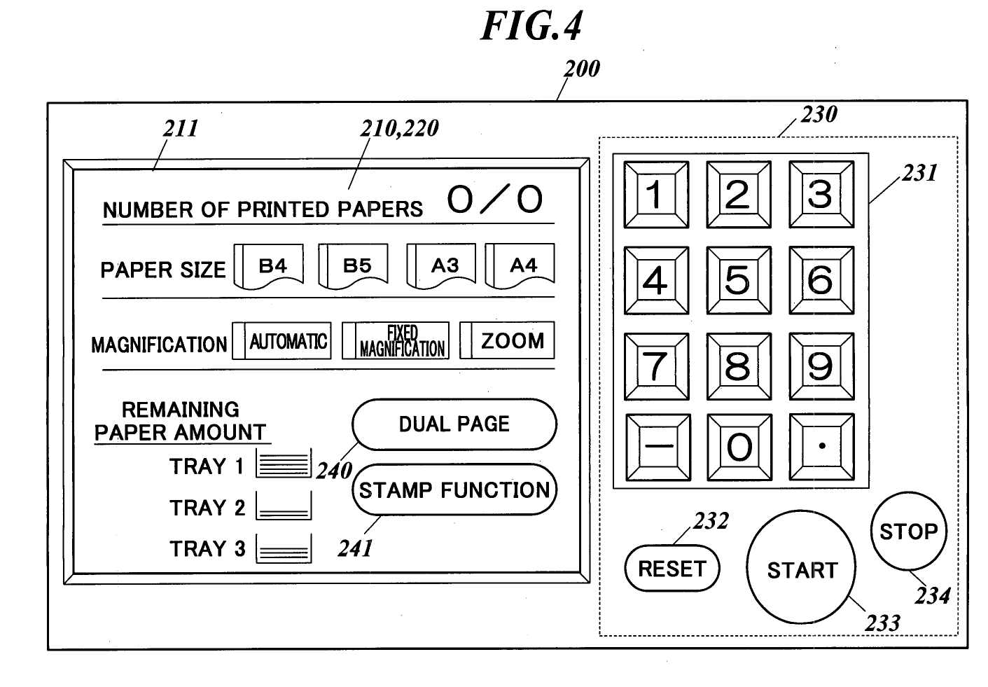

As shown in FIG. 2 and FIG. 4, the operation section 200 is structured to include the liquid crystal display section 210, the touch panel 220, the hardware key 230 or the like to accept an input from a user.

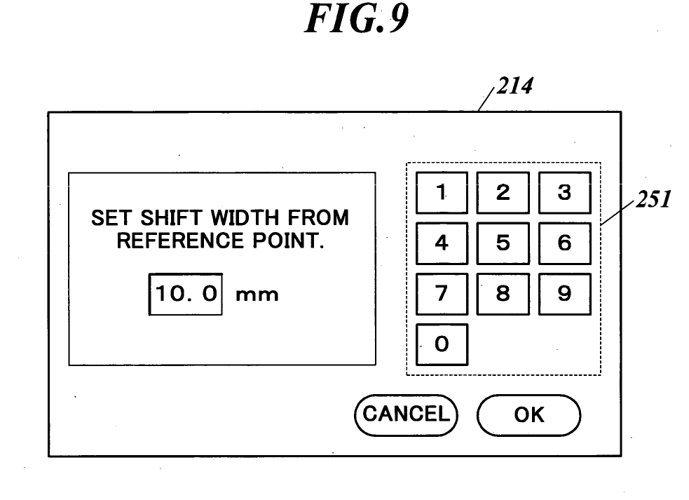

The liquid crystal display section 210 performs a display processing in accordance with a display signal from the control section 100. The liquid crystal display section 210 is used, for example, for displaying a screen (FIG. 8) in which a region to be added with a stamp (hereinafter referred to as stamp position) and a screen (FIG. 9) in which the shift width of the stamp position from a reference point is set.

The touch panel 220 is provided so as to cover the upper face of the liquid crystal display section 210 and detects a desired input position inputted by the depression of the panel by a finger or the like of the user to output the detected signal to the control section 100. The touch panel 220 is used, for example, when the user sets the dual page mode, when the user sets the stamp position, or when the user sets the shift width of the stamp position from the reference point.

The hardware key 230 outputs a depression signal generated by the operation of keys by the user to the control section 100. As shown in FIG. 4, the hardware key 230 includes the numeric keypad 231, the reset key 232, the start key 233, the stop key 234 or the like.

The image processing section 300 subjects the image data read by the scanner 11 to various image processings for adjusting color, brightness, and contrast or the like.

In accordance with the instruction from the control section 100, the image forming output section 400 forms and outputs an image based on the image data on the recording paper P. Specifically, the image forming output section 400 is structured to include the image forming section 40, the intermediate transfer belt 50, the paper feeding section 60, the fixation section 70 or the like included in the image forming apparatus body section 20.

The image reading apparatus of the present embodiment is structured by the control section 100, the image reading section 10, and the operation section 200.

Next, the operation of the image forming apparatus 1 in Embodiment 1 is described.

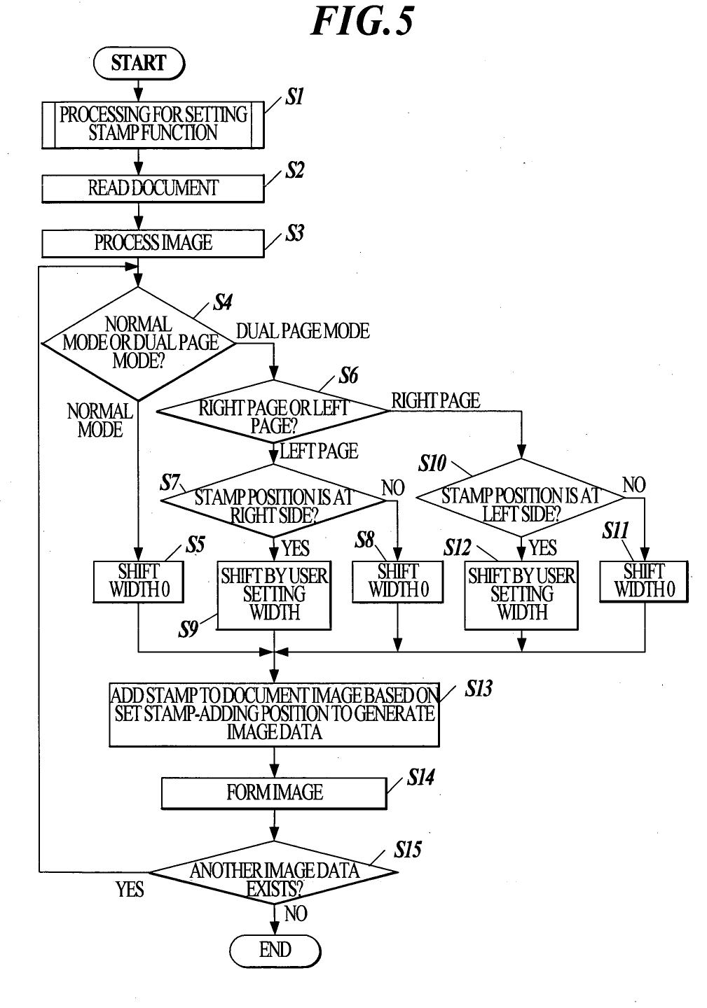

FIG. 5 is a flowchart illustrating the processing A for generating a stamp-added image. The processing A for generating a stamp-added image is a processing executed by the CPU 110 based on a program stored in the storage section 130. It is noted that, when the processing A for generating a stamp-added image is executed, whether a normal mode or a dual page mode is used for the processing is previously set by the user. The dual page mode is set, for example, by selecting the “dual page” button 240 shown in FIG. 4.

As shown in FIG. 5, a processing for setting the stamp function is firstly performed (Step S1). The stamp function is a function for adding a stamp to a specified position in the document image.

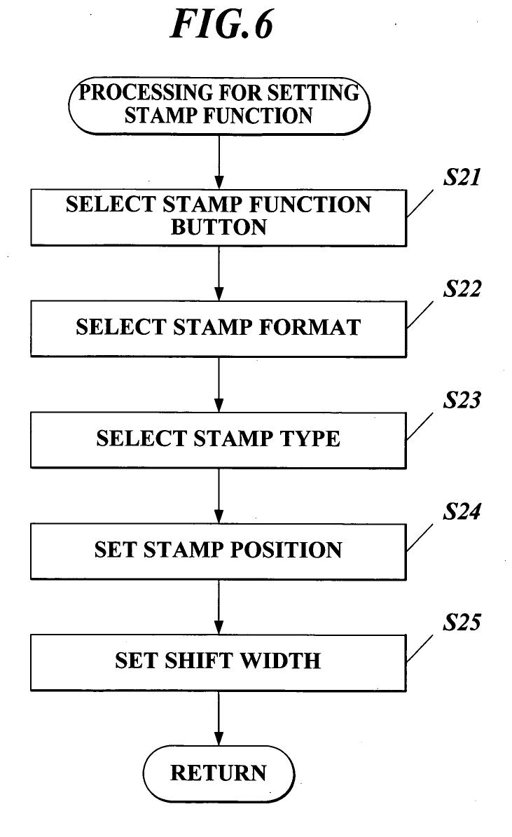

With reference to FIG. 6, a processing for setting the stamp function is described.

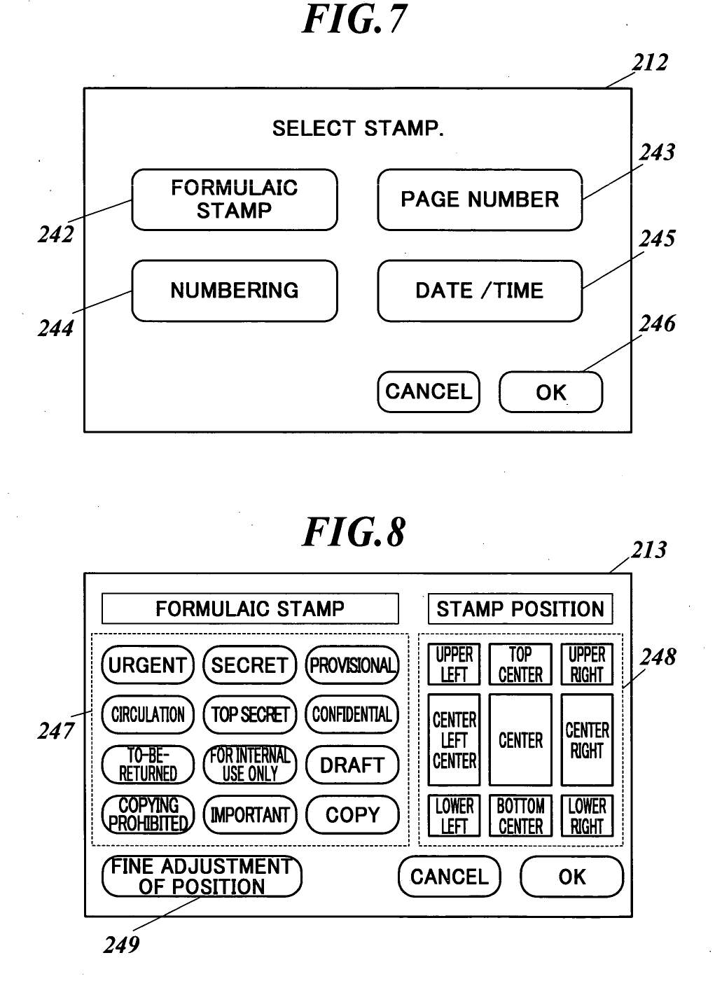

When the “stamp function” button 241 in the setting screen 211 shown in FIG. 4 is selected by the user (Step S21), the liquid crystal display section 210 displays the setting screen 212 as shown in FIG. 7 for selecting a stamp format (e.g., formulaic stamp, page number, numbering, date/time) and the stamp format is selected (Step S22). Specifically, any one of the “formulaic stamp” button 242, “page number” button 243, “numbering” button 244, and “date/time” button 245 is selected and the OK button 246 is selected.

The “formulaic stamp” is a function for adding previously prepared formulaic character(s) as a stamp. The “page number” is a function for adding a page number as a stamp. The “numbering” is a function for adding numbers in an order of document images. The “date/time” is a function for adding the date or time at which the document is read as a stamp. Among these stamps, the “numbering” may also be used for sequence numbers added to a proof in a discovery procedure in U.S. courts. Thus, the numbering is preferably provided such that, in order to secure the authenticity of read images, stamps are added to the images in a process from the time at which the images are read to the time at which the images are stored as image data that can be accessed from outside and that can be reused. The “date/time” are also preferably provided such that, for the purpose of proving that the images existed at the time at which the images were read, stamps are similarly added to the images in a process from the time at which the images are read to the time at which the images are stored.

For example, when the “formulaic stamp” button 242 is selected in the setting screen 212 of FIG. 7, the liquid crystal display section 210 displays the setting screen 213 as shown in FIG. 8 for specifying the type of the formulaic stamp and the stamp position. In the setting screen 213 shown in FIG. 8, the user specifies a stamp to be added, such as “URGENT”, “CIRCULATION”, “TO-BE-RETURNED”, from the stamp specification buttons 247 (Step S23). In the setting screen 213 shown in FIG. 8, the user uses the stamp position specification buttons 248 to specify the stamp position from the nine positions of “upper left”, “center left”, “lower left”, “top center”, “center”, “bottom center”, “upper right”, “center right”, and “lower right” (Step S24).

Next, when the stamp position is specified to be at a side in the binding margin region of the document image, a shift width for shifting the stamp position from the reference point is set (Step S25). Hereinafter, the shift width set in this manner is referred to as a user setting width.

When the “position fine adjustment” button 249 in the setting screen 213 shown in FIG. 8 is selected, the liquid crystal display section 210 displays the setting screen 214 as shown in FIG. 9 for fine-adjusting the stamp position. Then, the user uses the shift width setting buttons 251 to set the shift width from the reference point of the stamp position.

Next, returning to FIG. 5, by depressing the start key 233, the document is read by the scanner 11 to generate the document image (Step S2). The image data of the document image is subjected to various processings (e.g., trimming of the end section of the scan region, adjustment of color, brightness, and contrast) by the image processing section 300 (Step S3) and the processed data is temporarily stored in the RAM 120.

Next, the selected mode between the normal mode and the dual page mode is determined (Step S4). When the normal mode is selected (Step S4; normal mode), the shift width of the stamp position is set to be 0(zero) (Step S5). Specifically, the specified stamp position is directly set as the stamp-adding position.

When the dual page mode is selected (Step S4; dual page mode), whether the document image to which the stamp is to be added is an image corresponding to a right page or a left page is determined (Step S6).

When the document image to which the stamp is to be added is an image corresponding to a left page (Step S6; left page), whether the specified stamp position is at the right side or not (upper right, center right, lower right) (i.e., whether or not the specified stamp position is in a region at a side at which the binding margin region of the document region is positioned) is determined (Step S7). When the specified stamp position is not at the right side (Step S7; NO), the shift width of the stamp position is set to be 0(zero) (Step S8). Specifically, the specified stamp position is directly set as the stamp-adding position.

When, in Step S7, the specified stamp position is at the right side (Step S7; YES), then the specified stamp position is shifted to the left from the right end section of the document image by the user setting width and a position in the region of the document image away from the binding margin region is set as a stamp-adding position (Step S9).

When, in Step S6, the document image to which the stamp is to be added corresponds to a right page (Step S6; right page), whether the specified stamp position is at the left side (upper left, center left, lower left) or not (i.e., whether or not the specified stamp position is in a region at a side at which the binding margin region of the document region is positioned) is determined (Step S10). When the specified stamp position is not at the left side (Step S10; NO), then the shift width of the stamp position is set to be 0(zero) (Step S11). Specifically, the specified stamp position is directly set as the stamp-adding position.

When, in Step S10, the specified stamp position is at the left side (Step S10; YES), then the specified stamp position is shifted to the right by the user setting width from the left end section of the document image, thereby setting a position within the document image region away from the binding margin region as a stamp-adding position (Step S12).

After Step S5, Step S8, Step S9, Step S11, and Step S12, based on each set stamp-adding position, the document image is added with the stamp and image data is generated (Step S13). When a predetermined image (e.g., image of a formulaic stamp) is added, information to be added may be stored as character data and this character data may be read simultaneously with the reading of font data to generate stamp image data to add the generated stamp image data to the document image. This generation processing is included in Step S13. On the other hand, when a character image to be added changes (e.g., image of date/time, page number, numbering), the character data to be added is calculated and, based on this calculation result, image data is generated based on the font data. Then, this image data may be added to the document image as a stamp. This generation processing is included in Step S13. In the case of a character image to be added is image of a page number and a numbering, a number to be added is different for each page and thus a counter may be provided to know the number to be added to each document image. Then, based on the generated image data, the image forming output section 400 forms the image (Step S14).

Next, whether image data of another document image exists or not is determined (Step S15). When image data of another document image exists (Step S15; YES), the processing returns to Step S4. When image data of another document image does not exist (Step S15; NO), the processing A for generating a stamp-added image is completed.

FIG. 10 shows an example of image data that is generated when a stamp is added to the binding margin region side (upper right of FIG. 10) of the document image corresponding to a left page under the dual page mode. The user setting width y is set to have a value larger than the value of the width of the binding margin region (hereinafter referred to as binding margin width) x. By shifting the stamp region 530 from the right end section of the scanned-and-trimmed region 510 to the left by the user setting width y, the stamp can be added to a position away from the binding margin region 520.

As described above, the image forming apparatus 1 of Embodiment 1 can prevent, when a stamp is added to the document image read under the dual page mode, the stamp from being hidden. The image forming apparatus 1 of Embodiment 1 also allows, only when the stamp position is at the binding margin region side (i.e., only when the stamp position needs to be changed), the stamp to be shifted from the end section of the binding margin region-side document image by the user setting width, thereby adding the stamp to a position in the document image away from the binding margin region.

### Embodiment 2

Next, Embodiment 2 to which the present invention is applied is described.

The image forming apparatus shown in Embodiment 2 has the same structure as that of the image forming apparatus 1 shown in Embodiment 1. Thus, the same components are denoted with the same reference numerals and are not illustrated and described further. Hereinafter, a characteristic processing in Embodiment 2 is described.

In Embodiment 2, when a stamp position is specified in a binding margin region of the document image, the stamp position is shifted based on the width of the binding margin and, when the user setting width is set, the stamp position is further shifted by the user setting width.

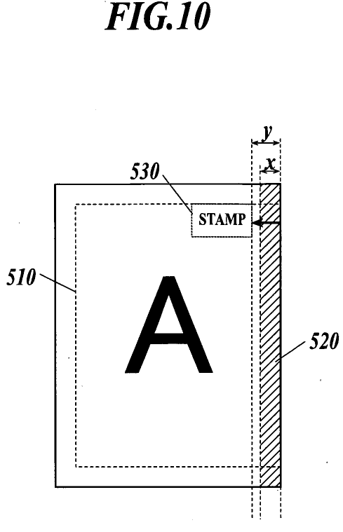

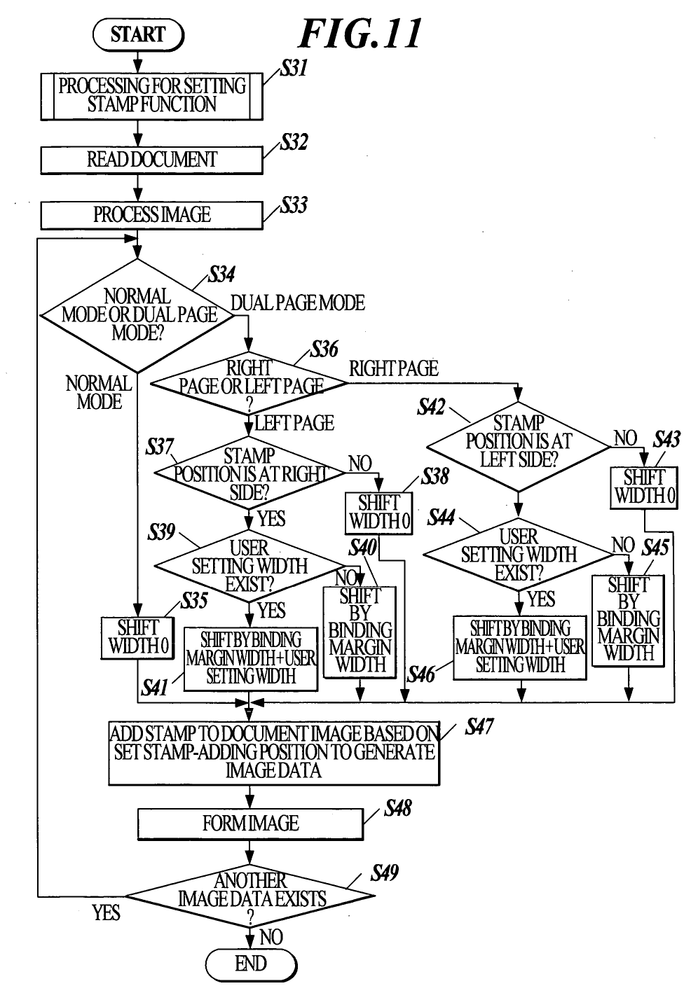

FIG. 11 is a flowchart illustrating the processing B for generating a stamp-added image. The processing B for generating a stamp-added image is a processing executed by the CPU 110 based on a program stored in the storage section 130. It is noted that, when the processing B for generating a stamp-added image is executed, whether the processing is performed with the normal mode or with the dual page mode is previously set by the user.

As shown in FIG. 11, a processing for setting the stamp function is firstly performed (Step S31). The processing for setting the stamp function is the same as the processing for setting the stamp function shown in FIG. 6 and thus is not described further. However, whether the shift width setting of Step S25 is performed or not can be selected by the user.

Next, when the start key 233 is depressed, the scanner 11 reads the document to obtain the document image (Step S32). The image data of the document image is subjected to various image processings (e.g., trimming of the end section of the scan region, adjustment of color, brightness, and contrast) by the image processing section 300 (Step S33) and the resultant data is temporarily stored by the RAM 120.

Next, whether the normal mode or the dual page mode is selected or not is determined (Step S34). When the normal mode is selected (Step S34; normal mode), the shift width of the stamp position is set to be 0(zero) (Step S35). Specifically, the specified stamp position is directly set as the stamp-adding position.

When the dual page mode is selected (Step S34; dual page mode), then whether the document image to which the stamp is to be added is an image corresponding to a right page or a left page is determined (Step S36).

When the document image to which the stamp is to be added is an image corresponding to a left page (Step S36; left page), whether the specified stamp position is at the right side (upper right, center right, lower right) (i.e., whether or not the specified stamp position is in a region at a side at which the binding margin region of the document region is positioned) is determined (Step S37). When the specified stamp position is not at the right side (Step S37; NO), the shift width of the stamp position is set to be 0(zero) (Step S38). Specifically, the specified stamp position is directly set as the stamp-adding position.

When, in Step S37, the specified stamp position is at the right side (Step S37; YES), then whether the user setting width is set or not is determined (Step S39). When the user setting width is not set (Step S39; NO), then the specified stamp position is shifted to the left from the right end section of the document image by the width of the binding margin and a position within the region of the document image away from the binding margin region is set as a stamp-adding position (Step S40).

When, in Step S39, the user setting width is set (Step S39; YES), then specified stamp position is shifted to the left from the right end section of the document image by a width obtained by adding the binding margin width and the user setting width and a position within the region of the document image away from the binding margin region is set as a stamp-adding position (Step S41).

When, in Step S36, the document image to which the stamp is to be added corresponds to a right page (Step S36; right page), whether the specified stamp position is at the left side (upper left, center left, lower left) (i.e., whether or not the specified stamp position is in a region at a side at which the binding margin region of the document region is positioned) is determined (Step S42). When the specified stamp position is not at the left side (Step S42; NO), the shift width of the stamp position is set to be 0(zero) (Step S43). Specifically, the specified stamp position is directly set as the stamp-adding position.

When, in Step S42, the specified stamp position is at the left side (Step S42; YES), then whether the user setting width is set or not is determined (Step S44). When the user setting width is not set (Step S44; NO), then the specified stamp position is shifted to the right from the left end section of the document image by the binding margin width and a position within the region of the document image away from the binding margin region is set as a stamp-adding position (Step S45).

When, in Step S44, the user setting width is set (Step S44; YES), then the specified stamp position is shifted to the right from the left end section of the document image by a width obtained by adding the binding margin width and the user setting width and a position within the region of the document image away from the binding margin region is set as a stamp-adding position (Step S46).

After Step S35, Step S38, Step S40, Step S41, Step S43, Step S45, and Step S46, based on each set stamp-adding position, the document image is added with the stamp and the image data is generated (Step S47). Then, based on the generated image data, the image forming output section 400 forms the image (Step S48).

Next, whether image data of another document image exists or not is determined (Step S49). When image data of another document image exists (Step S49; YES), the processing returns to Step S34. When image data of another document image does not exist (Step S49; NO), the processing B for generating a stamp-added image is completed.

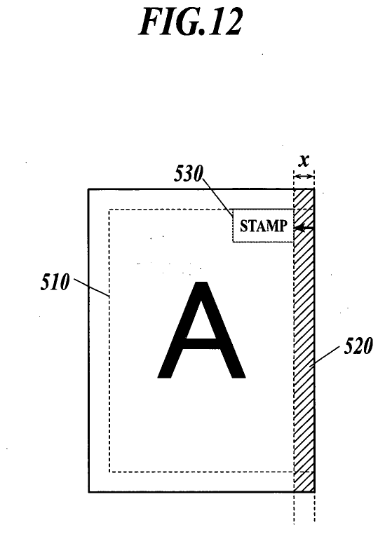

FIG. 12 shows an example of image data that is generated when a stamp is added to the binding margin region side (upper right of FIG. 12) of the document image corresponding to a left page under the dual page mode and when the user setting width is not set. By shifting the stamp region 530 from the right end section of the scanned-and-trimmed region 510 to the left by the binding margin width x, the stamp can be added to a position away from the binding margin region 520.

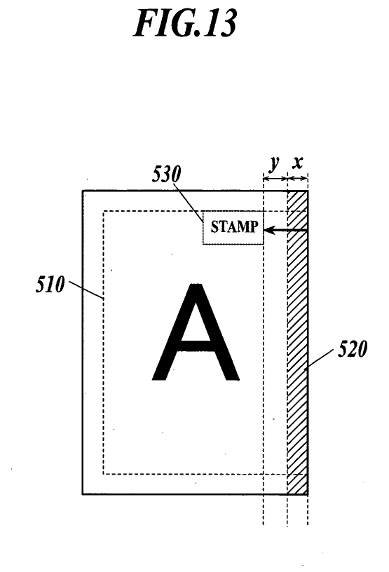

FIG. 13 shows an example of image data that is generated when a stamp is added to the binding margin region side (upper right of FIG. 13) of the document image corresponding to a left page under the dual page mode and when the user setting width is set. By shifting the stamp region 530 from the right end section of the scanned-and-trimmed region 510 to the left by a width obtained by adding the binding margin width x and the user setting width y, the stamp can be added to a position away from the binding margin region 520.

As described above, the image forming apparatus of Embodiment 2 can prevent, when a stamp is added to the document image read under the dual page mode, the stamp from being hidden. The image forming apparatus 1 of Embodiment 2 also allows, only when the stamp position is at the binding margin region side (i.e., only when the stamp position needs to be changed), the stamp to be added to a position of the document image away from the binding margin region. When the user setting width is not set, a position within the region of the document image in which the stamp is not hidden and which is closest to the binding margin region side can be added with the stamp. When the user setting width is set, a position can be added with the stamp within the region of the document image in which the stamp is not hidden that is further shifted from the position closest to the binding margin region by the user setting width.

### Embodiment 3

Next, Embodiment 3 using the present invention is described.

The image forming apparatus shown in Embodiment 3 has the same structure as that of the image forming apparatus 1 shown in Embodiment 1. Thus, the same components are denoted with the same reference numerals and are not illustrated and described further. Hereinafter, a characteristic processing in Embodiment 3 is described.

In Embodiment 1 and Embodiment 2, when a stamp position is specified in a binding margin region of the document image, the stamp position is shifted so that the stamp is added to a position away from the binding margin region. However, in Embodiment 3, when the stamp position is specified in a binding margin region of the document image, the size of the stamp is changed so that the stamp is added to a position away from the binding margin region.

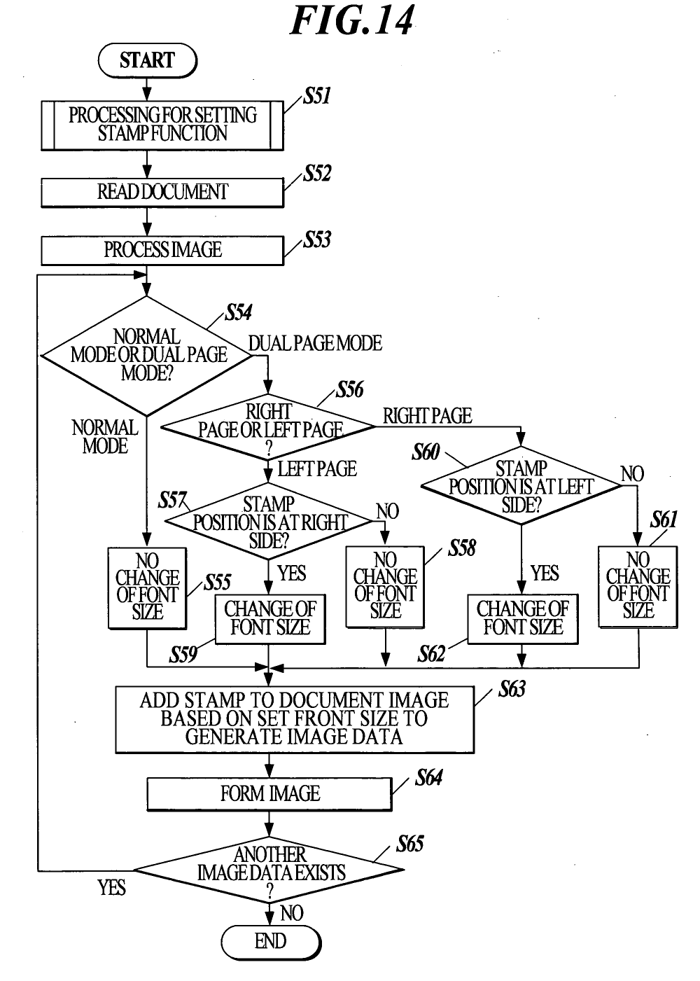

FIG. 14 is a flowchart illustrating the processing C for generating a stamp-added image. The processing C for generating a stamp-added image is a processing executed by the CPU 110 based on a program stored in the storage section 130. It is noted that, when the processing C for generating a stamp-added image is executed, whether the processing is performed with the normal mode or with the dual page mode is previously set by the user.

As shown in FIG. 14, a processing for setting the stamp function is firstly performed (Step S51). The processing for setting the stamp function is the same as the processing for setting the stamp function shown in FIG. 6 and thus is not described further. However, the shift width setting of Step S25 is not performed here.

Next, when the start key 233 is depressed, the scanner 11 reads the document to obtain the document image (Step S52). The image data of the document image is subjected to various image processings (e.g., trimming of the end section of the scan region, adjustment of color, brightness, and contrast) by the image processing section 300 (Step S53) and the resultant data is temporarily stored by the RAM 120.

Next, whether the normal mode or the dual page mode is selected or not is determined (Step S54). When the normal mode is selected (Step S54; normal mode), the font size of the stamp is not changed (Step S55).

When the dual page mode is selected (Step S54; dual page mode), then whether the document image to which the stamp is to be added is an image corresponding to a right page or a left page is determined (Step S56).

When the document image to which the stamp is to be added is an image corresponding to a left page (Step S56; left page), whether the specified stamp position is at the right side (upper right, center right, lower right) (i.e., whether or not the specified stamp position is in a region at a side at which the binding margin region of the document region is positioned) is determined (Step S57). When the specified stamp position is not at the right side (Step S57; NO), the font size of the stamp is not changed (Step S58).

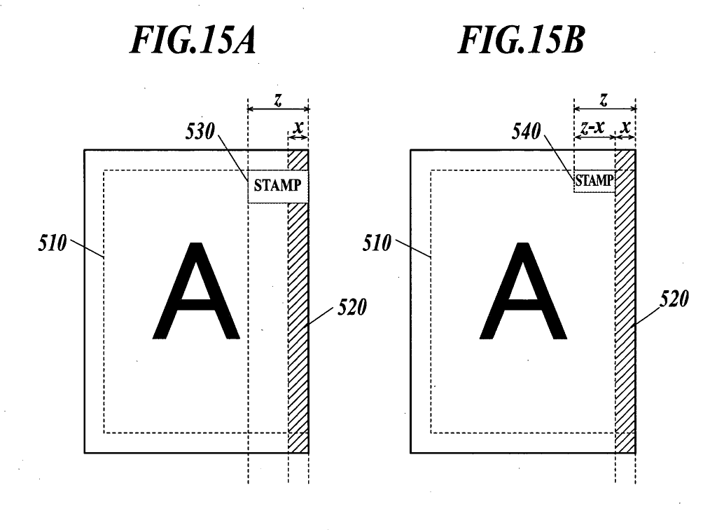

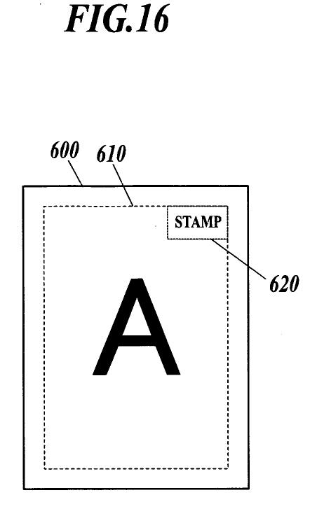

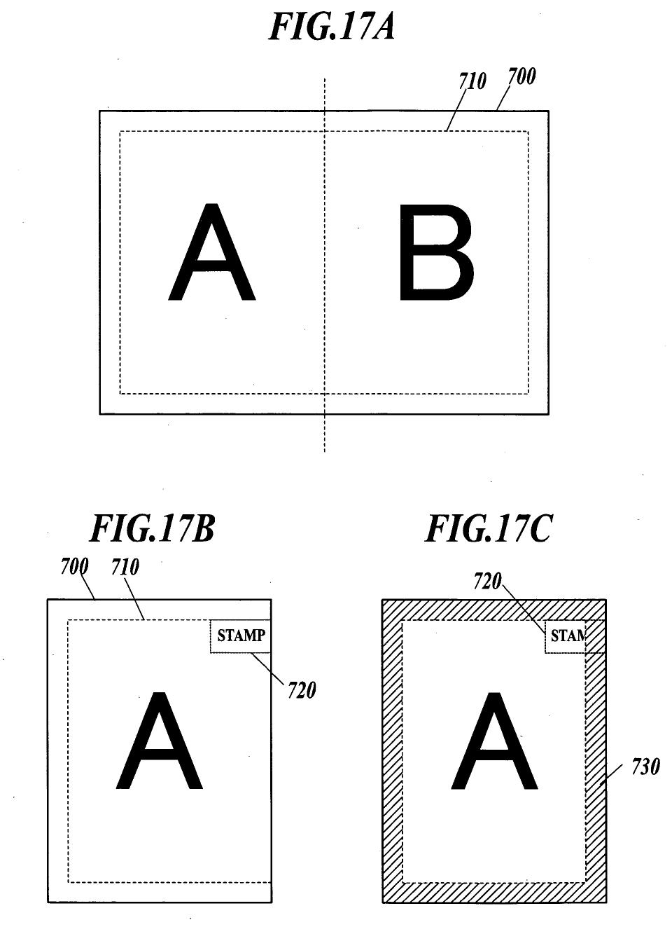

When, in Step S57, the specified stamp position is at the right side (Step S57; YES), then the font size of the stamp is changed (Step S59). For example, when the stamp position is specified at the upper right side as shown in FIG. 15A, the stamp region 530 overlaps with the binding margin region 520 in a case of using a previously-set font size. In order to add the stamp to a position away from the binding margin region 520, the stamp region 530 is scaled down. Specifically, the stamp region 530 is scaled down so that a previously-set width of the stamp region 530 (hereinafter referred to as stamp width) z is scaled down by the amount of the binding margin width x. Then, as shown in FIG. 15B, the right end section of the scaled-down stamp region 540 is moved to the left from the right end section of the scanned-and-trimmed region 510 by the binding margin width x. However, since the font size is limited to the previously prepared size (e.g., 8 points, 10 points, 12 points), the font size is changed to the maximum font size among font sizes obtained by multiplying the previously-set font sizes by (z-x)/z.

When, in Step S56, the document image to which the stamp is to be added corresponds to a right page (Step S56; right page), whether the specified stamp position is at the left side (upper left, center left, lower left) (i.e., whether or not the specified stamp position is in a region at a side at which the binding margin region of the document region is positioned) is determined (Step S60). When the specified stamp position is not at the left side (Step S60; NO), the font size of the stamp is not changed (Step S61).

When, in Step S60, the specified stamp position is at the left side (Step S60; YES), then the font size of the stamp is changed (Step S62). The method for changing the font size is the same as that in Step S59.

After Step S55, Step S58, Step S59, Step S61, and Step S62, based on each set font size, the document image is added with the stamp and the image data is generated (Step S63). Then, based on the generated image data, the image forming output section 400 forms the image (Step S64).

Next, whether image data of another document image exists or not is determined (Step S65). When image data of another document image exists (Step S65; YES), the processing returns to Step S54. When image data of another document image does not exist (Step S65; NO), the processing C for generating a stamp-added image is completed.

As described above, the image forming apparatus of Embodiment 3 can prevent, when a stamp is added to the document image read under the dual page mode, the stamp from being hidden. The image forming apparatus of Embodiment 3 also allows, only when the stamp position is at the binding margin region side (i.e., only when the size of the stamp needs to be changed), the stamp to be added to a position of the document image away from the binding margin region. This can prevent the stamp from being overlapped with the binding margin region. The change of the size of the font used for the stamp can also facilitate the change of the size of the stamp.

It is noted that the descriptions in the above embodiments show an illustrative embodiment of the image reading apparatus according to the present invention and the present invention is not limited to them. Thus, detailed structure and operation of the respective apparatuses may also be appropriately changed within the scope not deviating from the gist of the present invention.

For example, although Embodiment 1 to Embodiment 3 have described a case in which an image to be outputted in which the document image read by the image reading section 10 is added with the stamp is outputted from the image forming output section 400, the present invention is not limited to this. For example, the image forming apparatus may also include HDD so that image data of the image to be outputted is outputted to and stored in the HDD. Alternatively, the image forming apparatus may also include a communication section composed of an NIC (Network Interface Card) or the like so that image data of an image to be outputted is outputted via the communication section to an external device connected with network (e.g., PC). When image data of an image to be outputted is stored in or is outputted to an external device, the data may have a file format that can be viewed by a general-purpose PC (e.g., PDF file). In this case, the data may be limited for the use in order to prevent the file from being edited or modified by the general-purpose PC. When the data is stored in a file and outputted, a separate file may be prepared for each page of read document or one file may be used to include the document corresponding to a plurality of sequentially read pages.

When a user in Embodiment 1 and Embodiment 2 sets a width for shifting the stamp position from the reference point, a direction for the shift may also be set. For example, the shift width may also be set in two shift directions (e.g., 10.0 mm to the left and 15.0 mm down).

The present application is based on Japanese Patent Application No. 2005-261958 filed on Sep. 9, 2005 with Japan Patent Office.

What is claimed is:

1. An image reading apparatus comprising:
an image reading section for reading a document to obtain a document image; and
a control section for adding an additional image to a document image corresponding to one page in the document image obtained by the image reading section under a dual page mode to generate image information of the document image added with the additional image,
wherein the control section adds the additional image to the document image corresponding to one page away from a binding margin region.

2. The image reading apparatus of claim 1, further comprising an operation section for accepting an input from a user;
wherein the dual page mode is set based on a user instruction from the operation section.

3. The image reading apparatus of claim 1, wherein the control section adds the additional image to a position that is shifted by a width of the binding margin region from an end section of the document image corresponding to one page, the binding margin region being positioned at the end section.

4. The image reading apparatus of claim 2, wherein the control section adds the additional image to a position that is shifted by a width set by the user through the operation section from an end section of the document image corresponding to one page, the binding margin region being positioned at the end section.

5. The image reading apparatus of claim 2, wherein the control section adds the additional image to a position that is shifted by a width obtained by adding a width of the binding margin region and a width set by the user through the operation section from an end section of the document image corresponding to one page, the binding margin region being positioned at the end section.

6. The image reading apparatus of claim 1, wherein the control section changes a size of the additional image to add the additional image to the document image corresponding to one page away from the binding margin region.

7. The image reading apparatus of claim 6, wherein the control section changes the font size used in the additional image to add the additional image to the document image corresponding to one page away from the binding margin region.

8. The image reading apparatus of claim 2, wherein the operation section accepts a specified region to which the additional image is to be added, from the user; and
when the specified region is a region at which the binding margin region is positioned, the control section adds the additional image to the document image corresponding to one page away from the binding margin region.

9. The image reading apparatus of claim 6, further comprising an operation section for accepting a specified region to which the additional image is to be added, from the user; and
when the specified region is a region at which the binding margin region is positioned, the control section adds the additional image to the document image corresponding to one page away from the binding margin region.

10. An image reading method comprising:
obtaining a document image by an image reading section under a dual page mode; and
adding an additional image to a document image corresponding to one page in the document image obtained by the image reading section away from a binding margin region to generate image information of the document image added with the additional image.

11. The image reading method of claim 10, wherein in the adding of the additional image, the additional image is added to a position that is shifted by a width of the binding margin region from an end section of the document image corresponding to one page, the binding margin region being positioned at the end section.

12. The image reading method of claim 10, wherein in the adding of the additional image, the additional image is added to a position that is shifted by a width set by the user from an end section of the document image corresponding to one page, the binding margin region being positioned at the end section.

13. The image reading method of claim 10, wherein in the adding of the additional image, the additional image is added to a position that is shifted by a width obtained by adding a width of the binding margin region and a width set by the user from an end section of the document image corresponding to one page, the binding margin region being positioned at the end section.

14. The image reading method of claim 10, wherein in the adding of the additional image, a size of the additional image is changed to add the additional image to the document image corresponding to one page away from the binding margin region.

15. The image reading method of claim 14, wherein in the adding of the additional image, a font size used in the additional image is changed to add the additional image to the document image corresponding to one page away from the binding margin region.

16. The image reading method of claim 10, further comprising accepting a specified region to which the additional image is to be added, from a user; wherein
in the adding of the additional image, when the specified region specified in the accepting of the specified region is a region at which the binding margin region is positioned, the additional image is added to the document image corresponding to one page away from the binding margin region.

17. A storage medium for storing a program for causing a computer to execute:
obtaining a document image by an image reading section under a dual page mode; and
adding an additional image to a document image corresponding to one page in the document image obtained by the image reading section away from a binding margin region to generate image information of the document image added with the additional image.

18. The storage medium for storing the program of claim 17, wherein in the adding of the additional image, the additional image is added to a position that is shifted by a width of the binding margin region from an end section of the document image corresponding to one page, the binding margin region being positioned at the end section.

19. The storage medium for storing the program of claim 17, wherein in the adding of the additional image, the additional image is added to a position that is shifted by a width set by the user from an end section of the document image corresponding to one page, the binding margin region being positioned at the end section.

20. The storage medium for storing the program of claim 17, wherein in the adding of the additional image, the additional image is added to a position that is shifted by a width obtained by adding a width of the binding margin region and a width set by the user from an end section of the document image corresponding to one page, the binding margin region being positioned at the end section.

21. The storage medium for storing the program of claim 17, wherein in the adding of the additional image, a size of the additional image is changed to add the additional image to the document image corresponding to one page away from the binding margin region.

22. The storage medium for storing the program of claim 21, wherein in the adding of the additional image, a font size used in the additional image is changed to add the additional image to the document image corresponding to one page away from the binding margin region.

23. The storage medium for storing the program of claim 17, wherein
the computer is caused to further execute:
accepting a specified region to which the additional image is to be added, from a user; and
in the adding of the additional image, when the specified region specified in the accepting of the specified region is a region at which the binding margin region is positioned, the additional image is added to the document image corresponding to one page away from the binding margin region.
